(19) United States
(12) Patent Application Publication
(10) Pub. No.: US 2026/0054972 A1
(43) Pub. Date: Feb. 26, 2026

(54) SYSTEMS AND METHODS FOR LIFT DEVICES WITH OPERATIONAL SYMBIOSIS

(71) Applicant: Oshkosh Corporation, Oshkosh, WI (US)

(72) Inventors: Nathaniel Hoover, Oshkosh, WI (US); Devin Rosencrance, Oshkosh, WI (US)

(21) Appl. No.: 19/086,338

(22) Filed: Mar. 21, 2025

Related U.S. Application Data
(60) Provisional application No. 63/686,986, filed on Aug. 26, 2024.
(60) Provisional application No. 63/741,303, filed on Jan. 2, 2025.

(51) Int. Cl. B66F 11/04; B66F 9/06

(52) U.S. Cl. CPC B66F 11/042; B66F 9/063; B66F 11/044

(57) ABSTRACT

A system includes a user interface, a first lift vehicle, and a second lift vehicle. The first lift vehicle includes a first work platform. The second lift vehicle includes a base, a second work platform, a lift assembly coupled between the base and the work platform, a lift actuator coupled to the lift assembly and configured to raise and lower the second work platform relative to the base, at least one tractive element, and a controller in communication with the user interface. The controller is configured to receive, from the user interface, a first control signal to lift the second work platform to a position proximate the first work platform, and instruct the lift actuator to raise the second work platform to the position proximate the first work platform.

### CROSS-REFERENCE TO RELATED PATENT APPLICATIONS

This application is based on and claims priority to U.S. Provisional Patent Application No. 63/741,303, filed Jan. 2, 2025, and U.S. Provisional Patent Application No. 63/686,986, filed Aug. 26, 2024, each of which is incorporated herein by reference in its entirety.

### BACKGROUND

Lift devices are commonly used to lift workers to elevated working locations. However, these lift devices often have limited material holding capacity and require descent to load additional material. Therefore, what is needed is a system and method for supplying a worker at elevation with additional materials.

### SUMMARY

In some aspects, the present disclosure relates to a system including: a user interface; a first lift vehicle including a first work platform; and a second lift vehicle including: a base; a second work platform; a lift assembly coupled between the base and the second work platform; a lift actuator coupled to the lift assembly and configured to raise and lower the second work platform relative to the base; at least one tractive element; and a controller in communication with the user interface and configured to: receive, from the user interface, a first control signal to lift the second work platform to a position proximate the first work platform; and instruct the lift actuator to raise the second work platform to the position proximate the first work platform.

In some aspects, the present disclosure relates to a system including: a user interface; a work lift vehicle including a first work platform; and a payload lift vehicle including: a base; a second work platform; a lift assembly coupled between the base and the second work platform; a lift actuator coupled to the lift assembly and configured to raise and lower the second work platform relative to the base; a traction element; a drive motor configured to drive the traction element; a steering system configured to steer the traction element; and a controller in communication with the user interface and configured to: receive, from the user interface, a first control signal to retrieve a payload; instruct the drive motor and the steering system to navigate from a work location of the work lift vehicle to a loading location; receive, from a load sensor, an indication that the payload is placed on the second work platform; and instruct the drive motor and the steering system to navigate to the work location.

In some aspects, the present disclosure relates to a method of controlling a payload lift vehicle, the method including: receiving, at a vehicle controller of a payload lift vehicle, a first control signal to retrieve a payload; navigating, via a drive motor and a steering system of the payload lift vehicle, from a work location of a work lift vehicle to a loading location; receiving, from a load sensor, an indication that the payload is placed on a work platform of the payload lift vehicle; and navigating, via the drive motor and the steering system, to the work location of the work lift vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1A is a side, perspective view of a lift vehicle in the form of a scissor lift with a lift assembly in a work or raised position, according to an exemplary embodiment;

FIG. 1B is a side, perspective view of the lift vehicle of FIG. 1A with a lift assembly in a stored or lowered position, according to an exemplary embodiment;

FIG. 2 is a side, perspective view of the lift vehicle of FIG. 1A;

FIG. 3 is a side, perspective view of the lift vehicle of FIG. 1A;

FIG. 4A-4E are various perspective views of several lift vehicles configured for use with a payload mule system, according to an exemplary embodiment;

FIG. 5 is a side, perspective view of a lift vehicle in the form of a boom lift, according to an exemplary embodiment;

FIG. 6 is a block diagram of a control system for controlling a payload mule operation, according to an exemplary embodiment;

FIG. 7 depicts a system including a payload vehicle and a work vehicle, according to an exemplary embodiment;

FIG. 8 depicts a payload vehicle and various work vehicles, according to an exemplary embodiment;

FIG. 9 is a schematic illustration of a lift vehicle including a dispensing mechanism on a platform, according to an exemplary embodiment; and

FIG. 10 is a schematic illustration of a lift vehicle including a winch, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology used herein is for the purpose of description only and should not be regarded as limiting.

Referring generally to the figures, a first lift device (e.g., a work device) and a second lift device (e.g., a payload mule) are shown. The first lift device includes a first communication module and the second lift device includes a second communication module. The first/second lift devices are configured to provide coordinated control via the communication modules. By way of example, the first lift device may be controlled by an operator, and the second lift device may coordinate (e.g., mirror, follow, mimic, augment, supplement, etc.) motion with the first lift device to supply a worker positioned on the work device with a payload (e.g., at elevation). In some embodiments, the second lift device may autonomously navigate between the first lift device and a various desired positions/zones (e.g., a loading zone, a parking zone, a charging zone).

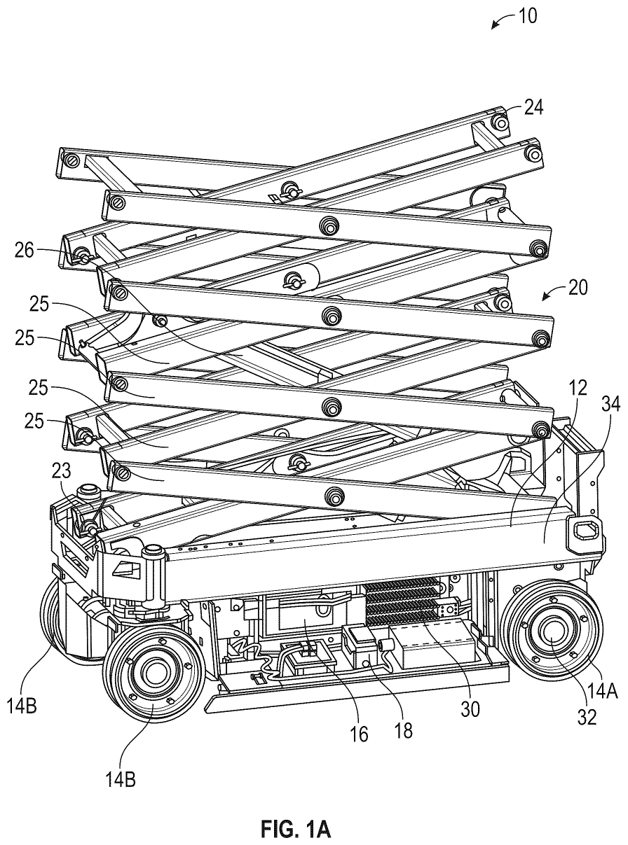

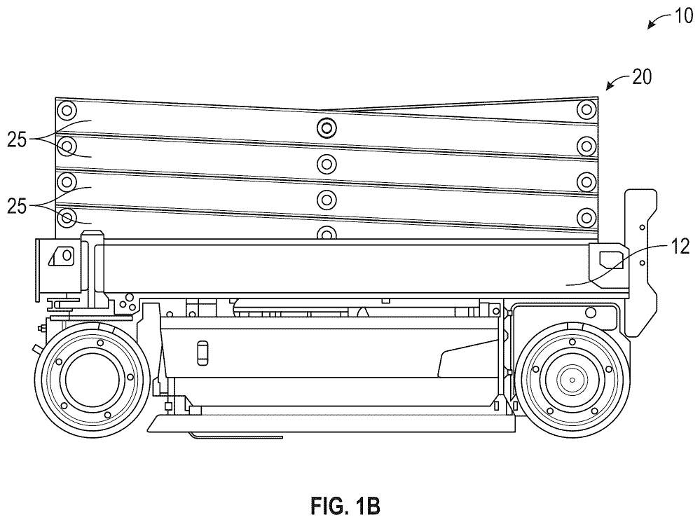

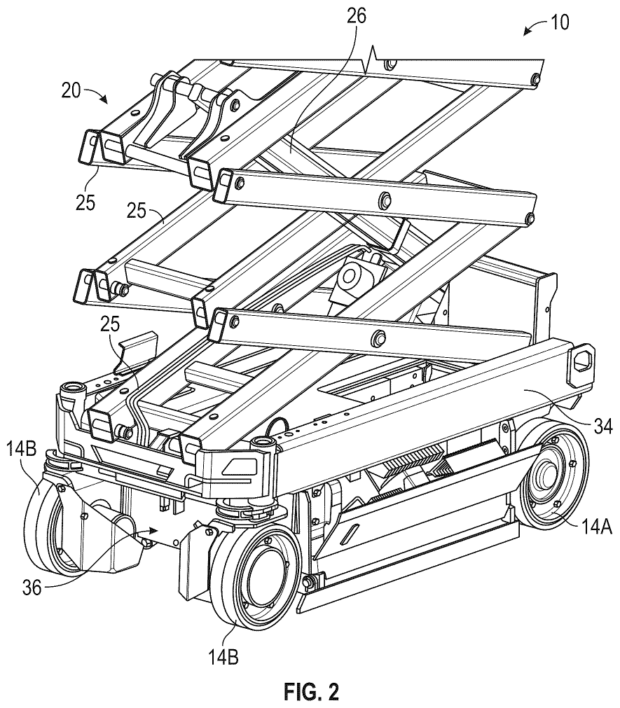

According to the exemplary embodiment depicted in FIGS. 1A-3, a lift vehicle, shown as vehicle 10, is illustrated. In some embodiments, the vehicle 10 may be a scissor lift, for example, which may be used to perform a variety of different tasks at various elevations. The vehicle 10 includes a chassis or frame, shown as base 12, supported by tractive elements 14A, 14B positioned about the base 12. The vehicle 10 further includes an energy storage device, shown as battery 16, positioned on board the base 12 of the vehicle 10 to supply electrical power to various operating systems present on the vehicle 10. In various embodiments, the vehicle 10 may also include an internal combustion engine for powering various systems of the vehicle 10 (e.g., a drivetrain).

The battery 16 may be a rechargeable lithium-ion battery, for example, which is capable of supplying electrical energy (e.g., a direct current (DC) or alternating current (AC)) to vehicle 10 controls, motors, actuators, and the like. The battery 16 may include at least one input 18 capable of receiving electrical current to recharge the battery 16 and/or directly power one or more other functions of the vehicle 10. In some embodiments, the input 18 is a port capable of receiving a plug for electrical communication with an external power source, such as a wall outlet. The battery 16 may be configured to receive and store electrical current from one of a 120V outlet, a 240V outlet, a 480V outlet, an electrical power generator, or another suitable electrical power source.

It should be appreciated that while the vehicle 10 is described as being powered by a battery and electrical actuators, the vehicle 10 may be powered by any number of suitable power sources. For example, the vehicle 10 may be powered by an internal combustion engine, a hydrogen engine, a propane engine, a fuel cell, etc.

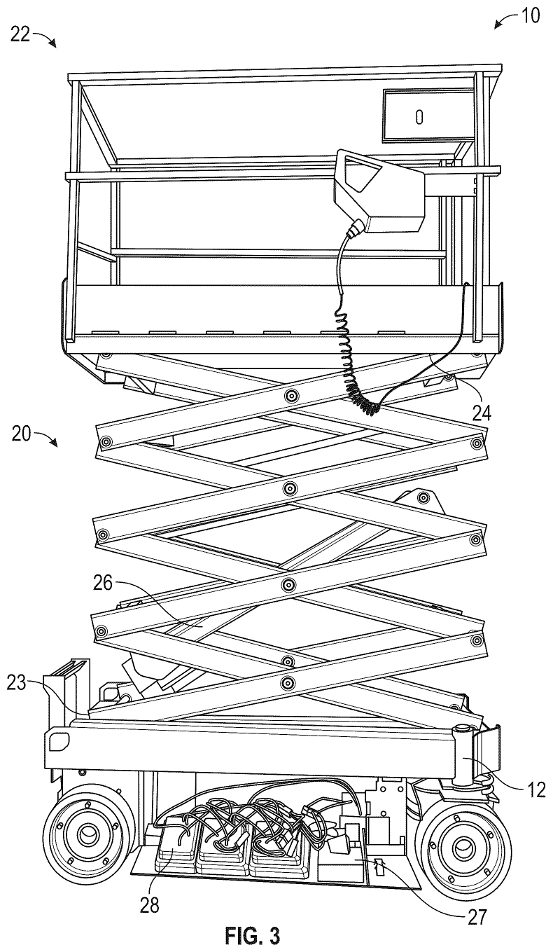

In various exemplary embodiments, the vehicle 10 further includes a retractable lift mechanism or lift assembly, shown as a lift assembly 20, coupled to the base 12. As shown, the lift assembly 20 is configured as a scissor lift mechanism. The lift assembly 20 supports an implement, shown as work platform 22 (see, e.g., FIG. 3). A first end 23 of the lift assembly 20 is anchored to the base 12, while a second end 24 of the lift assembly 20 supports the work platform 22. In the illustrated embodiment, the lift assembly 20 is formed of a series of linked, foldable support members 25. The lift assembly 20 is selectively movable between a retracted or stowed position (see, e.g., FIG. 1B) and a deployed or work position (see, e.g., FIG. 1A) using an actuator, shown as linear actuator 26. The linear actuator 26 is an electric actuator. The linear actuator 26 controls the orientation of the lift assembly 20 by selectively applying force to the lift assembly 20. When a sufficient force is applied to the lift assembly 20 by the linear actuator 26, the lift assembly 20 unfolds or otherwise deploys from the stowed or retracted position into the work position. Because the work platform 22 is coupled to the lift assembly 20, the work platform 22 is also raised away from the base 12 in response to the deployment of the lift assembly 20.

The battery 16 may also be in communication with the vehicle controller 27 (as shown in FIG. 3), which may command the battery 16 to selectively supply electrical power to one or more prime movers, shown as drive motor 30, to propel the vehicle 10. The drive motor 30 may similarly be an AC motor (e.g., synchronous, asynchronous, etc.) or a DC motor (shunt, permanent magnet, series, etc.) for example, which receives electrical power from the battery 16 or other electricity source on board the vehicle 10 and converts the electrical power into rotational energy in a drive shaft. The drive shaft may be used to drive the tractive elements 14A, 14B of the vehicle 10 using a transmission. The transmission may receive torque from the drive shaft and subsequently transmit the received torque to a rear axle 32 of the vehicle 10. Rotating the rear axle 32 also rotates the rear tractive elements 14A on the vehicle 10, which propels the vehicle 10. In some embodiments, an alternative power generator (e.g., internal combustion engine) may provide a torque force to the drive shaft of the vehicle 10. In some embodiments, one or more of the tractive elements 14A, 14B are independently driven by a drive motor 30.

The rear tractive elements 14A of the vehicle 10 may be used to drive the vehicle, while the front tractive elements 14B may be used to steer the vehicle 10. In some embodiments, the rear tractive elements 14A are rigidly coupled to the rear axle 32 and are held in a constant orientation relative to the base 12 of the vehicle 10 (e.g., approximately aligned with an outer perimeter 34 of the vehicle 10). In contrast, the front tractive elements 14B are pivotally coupled to the base 12 of the vehicle 10. The tractive elements 14B may be rotated relative to the base 12 (e.g., about respective vertical axes) to adjust a direction of travel for the vehicle 10. Specifically, the front tractive elements 14B may be oriented using an electrical steering system 36. In some embodiments, the steering system 36 may be completely electrical in nature and may not include any form of hydraulics. The tractive elements 14A, 14B may be any suitable tractive element for propelling the vehicle 10, including, but not limited to, wheels, tracks, casters, etc.

The vehicle 10 includes a vehicle controller 27 and a lift controller 28 (see, e.g., FIG. 3). The vehicle controller 27 is in communication with the lift controller 28 and is configured to control various driving systems on the vehicle 10 (e.g., the drive motor 30). The lift controller 28 is in communication with the linear actuator 26 to control the movement of the lift assembly 20. Communication between the lift controller 28 and the linear actuator 26 and/or between the vehicle controller 27 and the lift controller 28 may be provided through a hardwired connection (e.g., a CAN network), or through a wireless connection (e.g., Bluetooth, Internet, a cloud-based communication system, etc.). It should be understood that each of the vehicle controller 27 and the lift controller 28 includes various processing and memory components configured to perform the various activities and methods described herein. For example, in some instances, each of the vehicle controller 27 and the lift controller 28 includes a processing circuit having a processor and a memory. The memory is configured to store various instructions configured to, when executed by the processor, cause the vehicle 10 to perform the various activities and methods described herein. In some embodiments, the functionality of the lift controller 28 is performed by the vehicle controller 27 instead of the vehicle 10 including two separate controllers.

In some embodiments, the vehicle controller 27 may be configured to limit the drive speed of the vehicle 10 depending on a height of the work platform 22. That is, the lift controller 28 may be in communication with a scissor angle sensor configured to monitor a lift angle of the bottom-most support member 25 with respect to the base 12. Based on the lift angle, the lift controller 28 may determine the current height of the work platform 22. Using this height, the vehicle controller 27 may be configured to limit or proportionally reduce the drive speed of the vehicle 10 as the work platform 22 is raised.

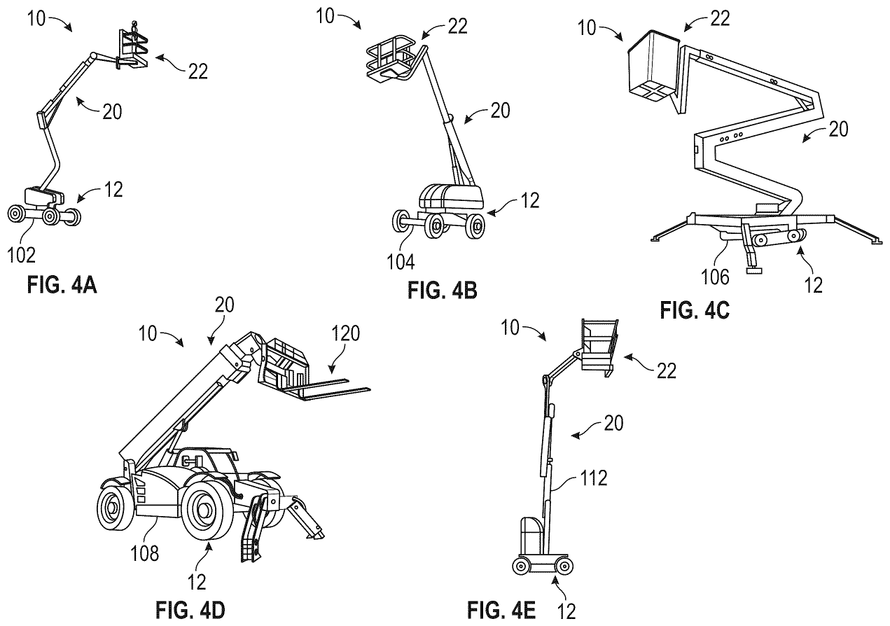

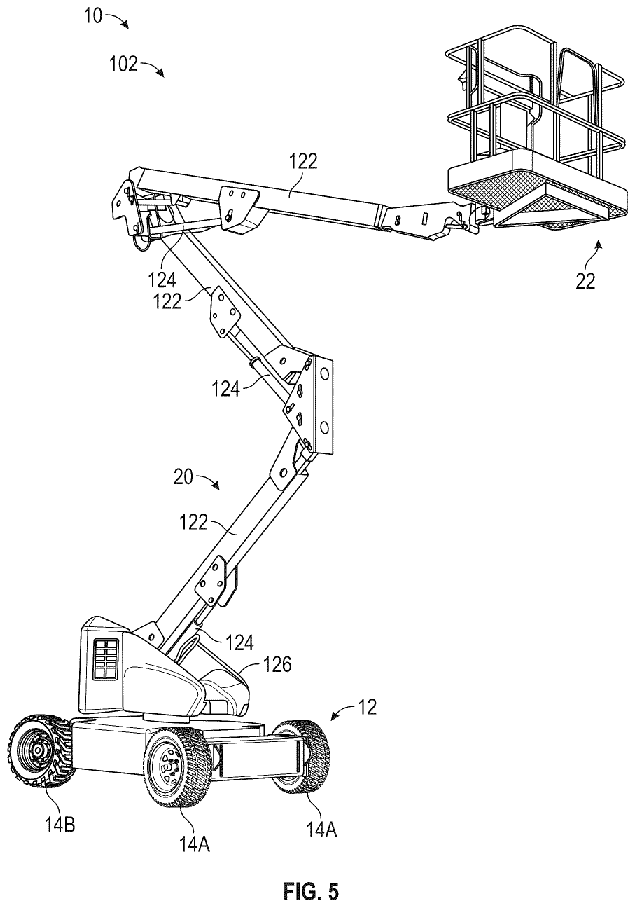

It should be appreciated that, while the retractable lift mechanism included on vehicle 10 is a scissor lift mechanism, in some instances, a vehicle may be provided that alternatively includes a lift mechanism of various forms. FIGS. 4 and 5 illustrate alternative types of lift devices usable with the systems and methods described herein. Each of the vehicles shown in FIG. 1-5 include a base 12, a lift assembly 20, and a work platform 22 or other type of implement that is raised and lowered relative to the base by the lift assembly 20.

Turning to FIGS. 4A-4E, the system and methods described herein may be implemented with the vehicle 10 being in various forms of a lift vehicle or a lift device, such as an articulating boom lift 102, a telescoping boom lift 104, a compact crawler boom lift 106, a telehandler 108, and/or a toucan mast boom lift or mast boom lift 112 (e.g., a vertical lift). As shown in FIG. 4A, the articulating boom lift 102 includes a work platform 22 that is raised and lowered by a lift assembly 20 configured as a multi-section, articulating boom assembly. As shown in FIG. 4B, the telescoping boom lift 104 includes a work platform 22 that is raised and lowered by a lift assembly 20 configured as a telescoping boom. As shown in FIG. 4C, the compact crawler boom lift 106 includes a work platform 22 that is raised and lowered by a lift assembly 20 configured as a multi-section, articulating boom assembly. As shown in FIG. 4D, the telehandler 108 includes an implement, shown as lift forks 120, that is raised and lowered by a lift assembly 20 configured as a telescoping boom. As shown in FIG. 4E, the mast boom lift 112 includes a work platform 22 that is raised and lowered by a lift assembly 20 configured as a mast boom assembly.

As described herein, the vehicle 10 may be in the form of the articulating boom lift 102. As shown in FIG. 5, the articulating boom lift 102 includes a retractable lift mechanism, shown as a lift assembly 20. The lift assembly 20 is configured as multi-section, articulating boom assembly and formed of a foldable series of linked support members 122. The lift assembly 20 is selectively movable between a retracted or stowed position and a deployed or work position using a series of actuators 124. Each of the series of actuators 124 may be a linear actuator similar to the linear actuator 26 of FIG. 1. The lift assembly 20 is coupled to the base 12 by a rotating member, shown as turntable 126. The turntable 126 is rotatably coupled to the base 12 and configured to rotate relative to the base 12 about a substantially vertical axis. In general, the actuation of the lift assembly 20 and the rotation of the turntable 126 (e.g., via a rotary actuator or motor) is configured to move the work platform within an aerial working envelope that includes a volume of space within which the work platform 22 may be moved by the lift assembly 20 and/or the turntable 126.

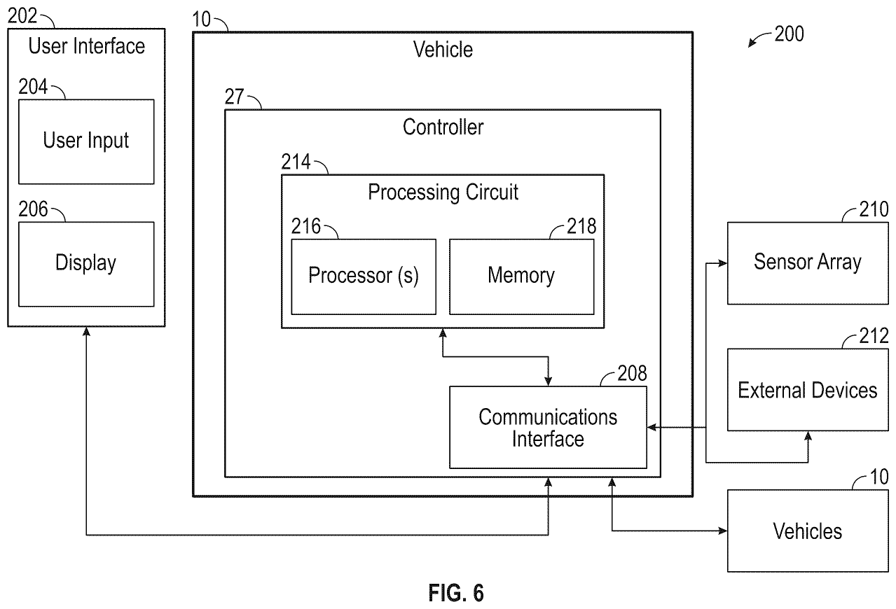

In general, the vehicles described herein may be included in a system that includes two or more vehicles that operate in a symbiotic relationship, with a first vehicle acting as a work vehicle where an operator is performing a task that requires materials (e.g., ducting, piping, drywall, framing, lighting, electrical conduits, or any other type of material), and a second vehicle acting as a delivery or mule vehicle that delivers the material to the platform of the first vehicle. In this way, for example, the operator of the first vehicle is not required to move from the work location to obtain more materials (e.g., descent from an elevated position, travel to a location to obtain more materials, and travel back to the work location). Rather, the second vehicle is configured to deliver materials to the operator at the position and height of the work location, and the operator can remain in the work location until the job is complete, which increases operational efficiency and reduces the amount of time required to complete the job. FIG. 6 shows an exemplary embodiment of a control system 200 that includes one or more of the vehicles 10 each including a prime mover (e.g., a spark ignition engine, a battery (e.g., the battery 16), a compression ignition engine, an electric motor, a generator set, a fuel cell, a hybrid system, etc.) structured to supply power to the vehicle 10, and an implement. In some embodiments, the implement is the lift assembly 20 (e.g., a boom lift, a scissor lift, a telehandler arm, etc.). The vehicle 10 may be in the form of any of the vehicles described herein (e.g., a scissor lift, the articulating boom lift 102, the telescoping boom lift 104, the compact crawler boom lift 106, the telehandler 108, the mast boom lift 112, etc.). The control system 200 further includes a user interface 202 in communication with the vehicle controller 27 via a communication interface 208, one or more sensor arrays 210, and one or more external devices 212.

The one or more user interfaces, shown as the user interface 202, is arranged in communication with the 10 to control operations of the vehicle 10 and the associated implement. The user interface 202 includes an input device, shown as user input 204, and an output device, shown as display 206. The user input 204 is configured to receive one or more interactions from an operator of the user interface 202. The user input 204 may include an electronic display, one or more graphical user interfaces, buttons, joysticks, scroll bars, radio buttons or dials, a computer mouse, a keyboard, a microphone, etc. The user input 204 may receive one or more interactions associated with one or more desired actions and transmit the received interaction (e.g., indication of the received interaction) to the vehicle controller 27 of the vehicle 10 via the communication interface 208. The display 206 is configured to communicate information to the machine operator (e.g., a display screen, a lamp or light, an audio device, a dial, or another display or output device). In some embodiments, a user interface 202 is coupled to the work platform 22 (e.g., for use by an operator positioned on the work platform 22). In other words, the user interface 202 may be included on the vehicle 10. In some embodiments, the user interface 202 is coupled to the base 12 (e.g., for use by an operator positioned on the ground). In some embodiments, the user interface 202 is remotely located from, and communicatively coupled to, the vehicle 10. By way of example, the user interface 202 may be or include a user device such as a smartphone, a laptop computer, a tablet, etc.

The vehicle controller 27 includes a processing circuit 214 including a processor 216 and a memory device, shown as memory 218. The processor 216 is configured to execute one or more instructions stored on the memory 218. The vehicle controller 27 is in communication with the communications interface 208. The communications interface 208 may facilitate communication between the vehicle controller 27 and other vehicles 10, the user interface 202, the sensor array 210, and/or external devices 212. The external devices 212 may include external inputs or outputs (e.g., a load map, a machine-to-machine communication, a fleet management system, a user interface, a network, etc.).

By way of example, the vehicle controller 27 may be or include one or more electronic control units (ECU), an implement control unit, an exhaust after-treatment control unit, a powertrain control module, an engine control module, etc. In some embodiments, the vehicle controller 27 is positioned offboard the vehicle 10 (e.g., in an on-site or offsite server, in a user device, in a controller of another vehicle, etc.). In some embodiments, the functionality of the vehicle controller 27 is distributed across multiple devices (e.g., a controller positioned onboard the vehicle 10, a controller positioned onboard another vehicle 10, and a server each perform a portion of the processing described with respect to the vehicle controller 27).

The vehicle controller 27 is configured to generate a range of inputs, outputs, and user interfaces, which may be displayed on the user interface 202 and/or the sensor array 210. The inputs, outputs, and user interfaces may be related to at least one of a jobsite, a status of a piece of equipment, environmental conditions, equipment telematics, an equipment location, task instructions, sensor data, equipment consumables data (e.g., a fuel level, a condition of a battery), status, location, or sensor data from another connected piece of equipment, communications link availability and status, hazard information, positions of objects relative to a piece of equipment, device configuration data, part tracking data, text and graphic messages, weather alerts, equipment operation, maintenance, and service data, equipment beacon commands, tracking data, performance data, cost data, operating and idle time data, remote operation commands, reprogramming and reconfiguration data and commands, self-test commands and data, software as a service data and commands, advertising information, access control commands and data, onboard literature, machine software revision data, fleet management commands and data, logistics data, equipment inspection data including inspection of another piece of equipment using onboard sensors, prioritization of communication link use, predictive maintenance data, tagged consumable data, remote fault detection data, machine synchronization commands and data including cooperative operation of machines, equipment data bus information, operator notification data, vehicle twinning displays, commands, and/or other data.

The sensor array 210 may include physical and virtual sensors for determining a state of the vehicle 10, a condition of the vehicle 10, a location of the vehicle 10, loads (e.g., weight on the work platform 22), and location devices. In some embodiments, the sensor array 210 includes a GPS device/sensor, one or more LIDAR sensors, one or more cameras, inertial navigation, and/or other sensors structured to determine a position/orientation of the vehicle 10 relative to one or more locations, maps, other equipment, objects, and/or other reference points. In an exemplary embodiment, the sensor array 210 includes sensors configured to measure positions of the vehicle 10 relative to other portions of the vehicle 10 (or other vehicles) or reference points, which are stored and processed by processing circuit 214. In some embodiments, the sensor values are recorded at time intervals (e.g., 1 second, 1 microsecond, etc.). In some embodiments, the most recent or current sensor value may be compared to one or more prior sensor values stored in memory 218 to detect changes in position, orientation, location, status, or other criteria. In an exemplary embodiment, the recorded sensor data is processed using a set of instructions (e.g., instructions stored in memory 218) to process the stored sensor values into a meaningful equivalent for viewing by a user (e.g., operator, manager, dealer, etc.). For example, electronic sensors (e.g., transducers) may output sensed information in the form of an electronic signal (e.g., voltage, current, analog signal, digital signal, etc.) that may be processed by the processing circuit 214, or by circuitry the sensor itself, to yield meaningful equivalents (e.g., position of a terminal end of the implement, an implement angle or position relative to another portion of the work equipment, temperature of a fluid, on/off status, etc.). The meaningful equivalents and/or the electronic signals may be viewable or accessible by the operator through the display 206.

In one configuration, the vehicle controller 27 includes a machine or computer-readable media that is executable by a processor, such as processor(s) 216. As described herein and amongst other uses, the machine-readable media facilitates performance of certain operations to enable reception and transmission of data. For example, the machine-readable media may provide an instruction (e.g., command, etc.) to, e.g., acquire data. In this regard, the machine-readable media may include programmable logic that defines the frequency of acquisition of the data (or, transmission of the data). The computer readable media may include code, which may be written in any programming language including, but not limited to, Java or the like and any conventional procedural programming languages, such as the “C” programming language or similar programming languages. The computer readable program code may be executed on one processor or multiple remote processors. In the latter scenario, the remote processors may be connected to each other through any type of network (e.g., CAN bus, etc.).

In another configuration, the vehicle controller 27 is embodied as hardware units, such as electronic control units. As such, the vehicle controller 27 may be embodied as one or more circuitry components including, but not limited to, processing circuitry, network interfaces, peripheral devices, input devices, output devices, sensors, etc. In some embodiments, the vehicle controller 27 may take the form of one or more analog circuits, electronic circuits (e.g., integrated circuits (IC), discrete circuits, system on a chip (SOCs) circuits, microcontrollers, etc.), telecommunication circuits, hybrid circuits, and any other type of “circuit.” In this regard, the vehicle controller 27 may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on). The vehicle controller 27 may also include programmable hardware devices such as field programmable gate arrays, programmable array logic, programmable logic devices or the like. The vehicle controller 27 may include one or more memory devices for storing instructions that are executable by the processor(s) of the vehicle controller 27. The one or more memory devices and processor(s) may have the same definition as provided below with respect to the memory 218 and processor 216. In some hardware unit configurations, the vehicle controller 27 may be geographically dispersed throughout separate locations in the machine.

In the example shown, the vehicle controller 27 includes the processing circuit 214 having the processor 216 and the memory 218. The processing circuit 214 may be structured or configured to execute or implement the instructions, commands, and/or control processes described herein with respect to the control system 200. The hardware and data processing components used to implement the various processes, operations, illustrative logics, logical blocks, modules and circuits described in connection with the embodiments disclosed herein (e.g., the processor 216) may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the one or more processors may be shared by multiple circuits (e.g., the vehicle controller 27 may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The memory 218 (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory 218 may be communicably connected to the processor 216 to provide computer code or instructions to the processor 216 for executing at least some of the processes described herein. Moreover, the memory 218 may be or include tangible, non-transient volatile memory or non-volatile memory. Accordingly, the memory 218 may include database components, object code components, script components, or any other type of information structure for supporting the various activities and information structures described herein.

In some embodiments, the user input 204 is incorporated into an electronic device non-physically coupled to the vehicle 10. In such embodiments, the electronic device may be used remote from the vehicle 10 to transmit and receive control/communication signals to and from the vehicle 10. By way of example, the user interface 202 may remotely transmit control signals to the vehicle 10 in response to receiving an indication of an interaction from the operator with the user input 204. The transmitted control signals may include instructions to move the vehicle 10, raise/lower a lift assembly 20 of the vehicle 10, autonomously navigate to a stored location, move other vehicles 10, raise/lower the lift assembly 20 of other vehicles 10, etc. For example, the user interface 202 may be configured to control operation of the first vehicle (e.g., the vehicle 10, the articulating boom lift 102, the telescoping boom lift 104, the compact crawler boom lift 106, the telehandler 108, the mast boom lift 112, etc.) and communicate with the second vehicle (e.g., the vehicle 10, the articulating boom lift 102, the telescoping boom lift 104, the compact crawler boom lift 106, the telehandler 108, the mast boom lift 112, etc.) so that the second vehicle is instructed to bring materials to a work location of the first vehicle and/or leave the work location of the first vehicle and bring back additional materials.

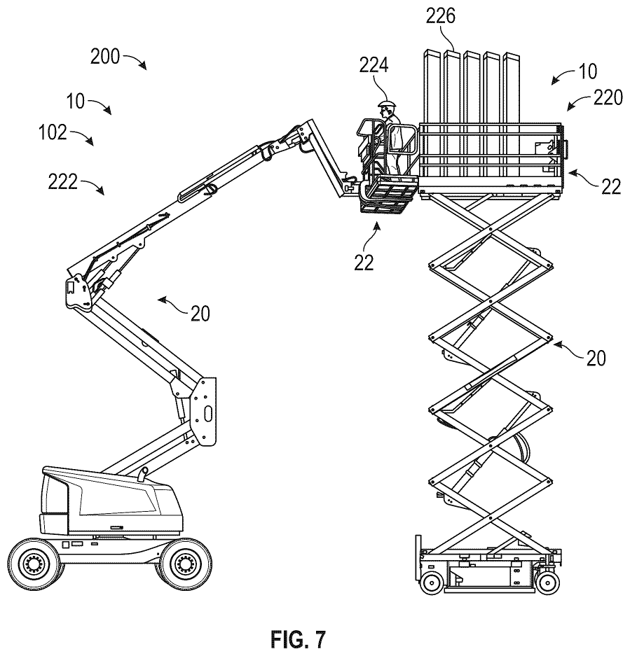

Turning now to FIG. 7, the control system 200 is shown with two vehicles working in tandem in a payload mule operation. The payload mule operation includes the vehicle 10, in the form of a scissor lift, acting as a second vehicle or a mule vehicle, shown as a payload vehicle 220, and the vehicle 10, in the form of the articulating boom lift 102, acting as a first vehicle or work vehicle 222. In an exemplary embodiment, the payload vehicle 220 is a remotely or autonomously operated vehicle used in assisting an operator 224 to perform various work functions at elevation or at a work location. “At elevation” may refer to any height above or below ground level. For example, as shown in FIG. 7, the operator 224 is positioned above ground level on the work platform 22 of the work vehicle 222. Several work processes and procedures may be performed by one or more workers at elevation. These may include, but are not limited to, painting, welding, installing various architectural components (e.g., lighting devices, electrical devices, finish trim, ductwork, plumbing components, structural framing, structural member, play material, drywall, roofing, communication networks), performing inspections, etc. In at least one implementation of the present disclosure, the payload vehicle 220 is a dedicated material lift handler, such as a scissor lift (e.g., the vehicle 10), that is a remotely, semi-autonomously, or autonomously operated to transport a payload or materials 226 to one or more workers or locations at elevation.

In some embodiments described herein, the payload vehicle 220 transports the payload 226 to operator 224 at elevation. The payload 226 may include any number of items and/or people. For example, the payload 226 may include construction materials (e.g., drywall, lumber, steel, trusses, paint, fasteners, finish materials, etc.), additional workers, and/or tools (e.g., welder, power equipment, power washers, media blasters, hand tools, communication devices, electrical storage devices, autonomous robotic devices, solar panels, etc.).

In some embodiments, the payload vehicle 220 may be a landing zone for unmanned aerial vehicles. For example, the work platform 22 of the payload vehicle 220 may provide a landing zone for a remotely (or semi-autonomously/autonomously) operated drone. The drone may be used to transport the payload 226 to the operator 224 at elevation. The work platform 22 of the payload vehicle 220 may provide a safe landing zone (e.g., distanced form the operator 224) for the unmanned aerial vehicle to place the payload 226 for the operator 224 to use in working at elevation.

The work platform 22 of the payload vehicle 220 may be certified to safely and appropriately handle any loaded payload 226 on the payload vehicle 220. By way of example, when lifting one or more persons, the work platform 22 may satisfy various certifications for lifting persons (e.g., required regulatory certifications).

In addition to being used to provide the operator 224 with the payload 226 at elevation, the payload vehicle 220 may be used to specifically position the payload 226 in place while the operator 224 installs and/or otherwise manipulates the payload 226. By way of example, the payload vehicle 220 may be loaded with a steel, structural truss on the work platform 22. The payload vehicle 220 may move while in the retracted (or deployed) position to a location directly under a position in which the steel, structural truss is to be placed. In some embodiments, the payload vehicle 220 positions itself such that the steel, structural truss is in an orientation in which it needs to be installed at elevation. The payload vehicle 220 may then elevate the steel, structural truss by deploying the scissor lift mechanism (e.g., the lift assembly 20) of the payload vehicle 220 until the steel, structural truss is in a position in which it must be installed: the truss being supported by the work platform 22 in the desired orientation. According to an exemplary embodiment, the operator 224, while in the elevated position, may install the steel, structural truss while it is being supported by the work platform 22 of the payload vehicle 220 in the desired orientation. For example, the operator 224 may perform one or more welds, install one or more fasteners, and or place the steel, structural truss in an installation position.

Although the above example includes a steel, structural truss, it should be understood that this method of installation may apply to any type of structural and/or architectural component (e.g., HVAC components, ductwork, plumbing, framing, communications networks, drywall, dropped ceiling, electrical, etc.). For example, the payload vehicle 220 may be used to position HVAC ductwork for the operator 224 to install at elevation. Likewise, the payload vehicle 220 may be used to position drywall sheets for the operator 224 to install at elevation.

In some embodiments, the work platform 22 of the payload vehicle 220 may be customizable and/or configurable in order to handle a variety of materials. For example, the work platform 22 may include a specialized drywall mount so that the payload vehicle 220 may hold a sheet of drywall vertically on a wall in an installation orientation for the operator 224 to install the drywall sheet. In some embodiments, the work platform 22 may be removeable platform that may be replaced with customizable platforms for specific use cases.

Additionally, in some embodiments, multiple payload vehicles 220 may be used in tandem to elevate materials that exceed the weight or size restrictions of a single vehicle. In other cases, multiple payload vehicles 220 may be used in tandem to elevate material to reduce wear on a single vehicle. In some embodiments, the vehicle controller 27 of the payload vehicle 220 is communicatively coupled (e.g., in communication with) to the vehicle controller 27 of the work vehicle 222 via the communication interfaces 208. The location, orientation, and/or position data associated with the payload vehicle 220 and/or the work platform 22 thereof may be communicated to all the payload vehicles within the control system 200. This two-way communication of location, orientation, and/or position may be used by each of the payload vehicles 220 within the control system 200 working in coordination to move in tandem so that each payload vehicle 220 may be aware of the location/position of each other payload vehicle 220. In this way, all payload vehicle 220 may raise and/or lower in coordination with each other.

In addition, the work vehicle 222 may also be communicatively coupled (e.g., in communication with) to the payload vehicle 220 and bi-directionally transmit and/or receive location, position, and/or orientation of both the payload vehicle 220 and the work vehicle 222. In doing so, the payload vehicle 220 may move in conjunction with work vehicle 222 to provide the operator 224 with materials on the jobsite at an elevated position while the work vehicle 222 transfers from a first position to a second position. By way of example, the operator 224 may install a length of ductwork at elevation using one of a plurality of lengths of ductwork loaded as the payload 226 on the work platform 22 of the payload vehicle 220. Upon installing the ductwork, the operator 224 may adjust the position of the work vehicle 222 (e.g., move the base 12 via the drive motor 30 and/or move a height of the work platform 22 via the linear actuator 26) to a second position to install a second length of ductwork. As the work vehicle 222 moves to the second position, the payload vehicle 220 may automatically receive data from the work vehicle 222 relating to a position, speed, movement, orientation, and/or elevation of the work vehicle 222. For example, the vehicle controller 27 of the payload vehicle 220 automatically receives data from the vehicle controller 27 of the work vehicle 222 (e.g., detected by the sensor array 210 of the work vehicle 222) relating to a position, speed, movement, orientation, and/or elevation of the work vehicle 222. Similarly, the vehicle controller 27 of the work vehicle 222 automatically receives data from the vehicle controller 27 of the payload vehicle 220 (e.g., detected by the sensor array 210 of the payload vehicle 220) relating to a position, speed, movement, orientation, and/or elevation of the payload vehicle 220. Upon receiving an indication of movement of the work vehicle 222, the payload vehicle 220 (with additional ductwork loaded thereon) may automatically adjust one or more operating parameters (e.g., speed, steering, elevation of work platform 22, operational state, etc.) to locate the work platform 22 of the payload vehicle 220 (and the loaded ductwork) proximate the work platform 22 of the work vehicle 222 for the worker's 224 ease of access. This coordinated movement (e.g., a leader-follower mode) may be selectively chosen by the operator 224 or other remote operator (e.g., via the user interface 202 or the external devices 212).

In some embodiments, the operator 224 (or any other operator) may have an electronic device (e.g., a mobile device, computer, tablet, remote control, control panel, server, the user interface 202) remote to payload vehicle 220 with which the operator 224 (or any other operator) may transmit control signals to the payload vehicle 220 remotely. By way of example, based on one or more received inputs by the operator 224, the electronic device may transmit control signals to the communication module of the payload vehicle 220 to adjust one or more operating parameters of the payload vehicle 220 (e.g., speed, steering, elevation of work platform 22, operational state). By way of example, the operator 224 may interact (e.g., through touch, voice, vision, etc.) with the electronic device, and in response to receiving the interaction, the electronic device may transmit control signals to the payload vehicle 220 to lower the work platform 22 once the payload 226 is depleted. The operator 224 may then remotely operate the payload vehicle 220, through control signals sent from the electronic device, to a loading location for additional payload 226 to be loaded. In some embodiments, a remote operator (distinct from the operator 224) may remotely operate the payload vehicle 220 through the use of the electronic device's control signals. In other embodiments, the payload vehicle 220 may have the loading location stored in a memory (remotely or locally) to which the payload vehicle 220 may autonomously navigate upon receiving an indication of a depletion of the payload 226. The payload vehicle 220 may receive an indication from the operator 224 or other remote operator to “return to loading location” upon the depletion of the payload 226. Responsive to receiving the indication to “return to loading location,” the payload vehicle 220 may automatically or autonomously navigate to the loading location. This “return to loading location” may include lowering the work platform 22 of the payload vehicle 220 or maintaining the work platform 22 of the payload vehicle 220 at elevation and adjusting one or more operating parameters to navigate to the stored loading location. The payload vehicle 220 may follow a predetermined navigation path or autonomously navigate to the loading location using various sensors (e.g., the sensor array 210) to sense the external environment. The payload vehicle 220 may use any suitable sensor (e.g., the sensor array 210) to sense the external environment including, but not limited to, LIDAR, ultrasound, radar, infrared camera, imaging device. In embodiments in which the payload vehicle 220 follows a predetermined navigation path, the predetermined navigation path may be saved remotely or local to the payload vehicle 220. In other embodiments, the predetermined navigation path may be transmitted to the payload vehicle 220 communication module over a network.

Once the payload vehicle 220 reaches the loading location, the vehicle controller 27 of the payload vehicle 220 may monitor the sensor array 210 (e.g., load or weight sensors coupled to the work platform 22) to determine when another payload 226 is placed on the work platform 22. Once the vehicle controller 27 determines that another payload 226 is placed on the work platform 22, the vehicle controller 27 may instruct the drive motor 30 and the electrical steering system 36 to navigate the payload vehicle 220 back to the work vehicle 222.

In one embodiment, the operator 224 may navigate the payload vehicle 220 to a desired ground location (e.g., loading zone, parking spot, charging spot) through control signals sent from the user interface 202 or the external devices 212. The operator 224 then transmits, by the user interface 202 or the external devices 212 to the vehicle controller 27 of the payload vehicle 220, an indication to save the current position (e.g., elevation, location, orientation) of the payload vehicle 220. Upon receiving the indication to save the current position, the payload vehicle 220 may query its position from one or more databases, servers, or electronic devices. In an exemplary embodiment, the payload vehicle 220 utilizes a GPS module to request its position and then store the received position. The operator 224 may transmit by the user interface 202 or the external devices 212 to the vehicle controller 27 of the payload vehicle 220, an indication of the type of position (e.g., loading zone, charging zone, parking spot) to associate with the saved position. Responsive to receiving, by the user interface 202 or the external devices 212, a request to return to the saved position, the payload vehicle 220 may query the saved position and navigate to the saved position. Likewise, the operator 224 may transmit, by the user interface 202 or the external devices 212, to the communication module of the payload vehicle 220, an indication of a recording mode. Responsive to receiving the recording mode, the payload vehicle 220 may begin recording various operating parameters and position data. During the recording mode, the user interface 202 or the external devices 212 may transmit control signals to the payload vehicle 220 to adjust various operating parameters. During the recording mode, the payload vehicle 220 records the transmitted controls and the associated positional data. In doing so, the payload vehicle 220 records a navigation path and corresponding operating parameters, which is stored for future use. The payload vehicle 220 may then access the recorded navigation path in response to receiving an indication from the user interface 202 or the external devices 212 to follow the recorded navigation path. After accessing the recorded navigation path, the payload vehicle 220 may automatically adjust the operating parameters to follow the recorded navigational path.

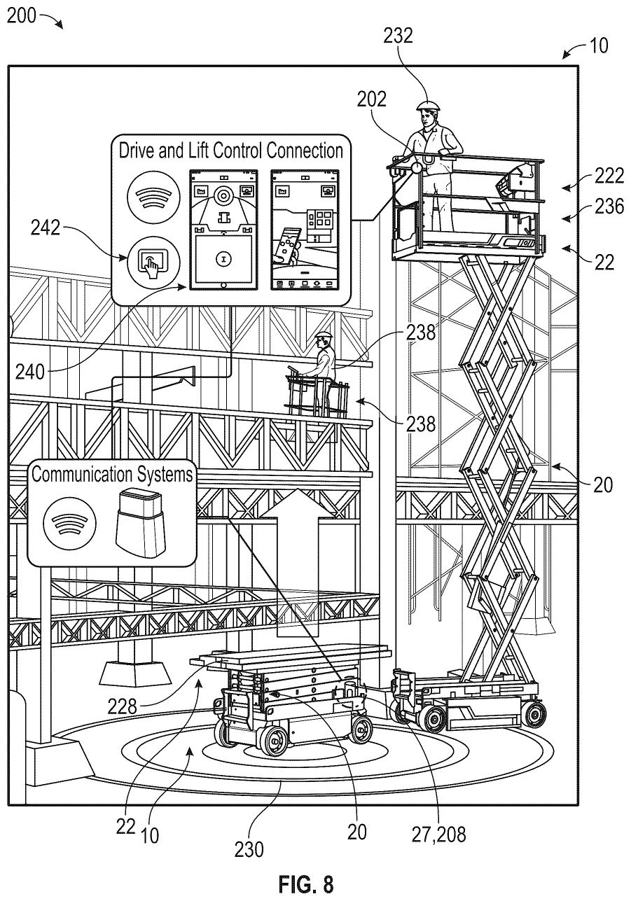

Turning now to FIG. 8, the control system 200 is shown with multiple vehicles working in tandem in a payload mule operation. The payload vehicle 220 is shown according to an exemplary embodiment. In the illustrated, the payload vehicle 220 is in the form of a scissor lift (e.g., an autonomous form of the vehicle 10 without an operator compartment on the work platform 22). In some embodiments, the payload vehicle 220 is a remotely, semi-autonomously, or autonomously controlled payload mule (e.g., material mule). The payload vehicle 220 includes the work platform 22 upon which a payload 228 is be supported. The payload vehicle 220 may also includes the vehicle controller 27 with the communication interface 208. As described in FIG. 7, the payload vehicle 220 may include the sensor array 210 that may transmit and receive data associated with the external environment (e.g., location of objects, location of other vehicles, position of the payload vehicle 220). As shown in FIG. 8, the payload vehicle 220 may have a perception area 230 inside which the payload vehicle 220 may perceive the external environment. In some embodiments, the payload vehicle 220 includes various sensors which have varying perception areas. For example, a camera may have a wider perception area 230 than a LiDAR perception area associated with a LiDAR sensor.

In some embodiments, the communication interface 208 of the payload vehicle 220 is communicatively coupled (e.g., in communication with) to one or more of the work vehicles 222. Each of the work vehicles 222 also includes a corresponding vehicle controller 27 and a communication interface 208 that may transmit/receive data between each payload vehicle 220 over a common communication protocol (e.g., Bluetooth, WiFi, cellular, radio, or other proprietary protocol). In FIG. 8, the work vehicles 222 are shown as a first work vehicle 236 and a second work vehicle 238 both coordinating with one remotely or autonomously operated payload vehicle 220 (e.g., payload mule). In some embodiments, a single payload vehicle 220 may service multiple operators 232, 234 on the multiple work vehicles 222. By way of example, the payload vehicle 220 may receive a payload 228 onto the work platform 22 thereof while in a retracted position. The payload vehicle 220 may then be remotely or autonomously operated to a position proximate the first work vehicle 236 such that when the work platform 22 of the payload vehicle 220 is deployed, the operator 232 may access the payload 228. The payload vehicle 220 then deploys the lift assembly 20 of the payload vehicle 220 to raise the work platform 22 (with loaded payload 228) to elevation. Once the work platform 22 of the payload vehicle 220 is at elevation, the multiple operators 232 may remove the payload 228 from the payload vehicle 220. Upon sensing the removal of the payload 228 (e.g., via the sensor array 210 in communication with the vehicle controller 27), the payload vehicle 220 may lower the lift assembly 20 and navigate to a loading station or to the second work vehicle 238. In other embodiments, the payload vehicle 220 receives a second payload 228 and then navigates to the first work vehicle 236 to repeat the process of supplying the multiple operators 232 with the second payload 228.

The navigation between the operators 232, 234, the multiple work vehicles 222, and loading zones may occur autonomously by the payload vehicle 220 or by remote operation by an operator using a remote control device. For example, an operator (e.g., operator 232, operator 234, or remote operator) may utilize a remote device (e.g., the user interface 202, a mobile device, computer, tablet, remote control, control panel, server) to transmit control signals to the payload vehicle 220 (e.g., by way of the communication interface 208) to adjust various operating parameters (e.g., speed, steering, elevation of work platform 22, operational state, etc.). Upon receiving the transmitted control signals, the payload vehicle 220 automatically adjusts the operating parameters to reflect the transmitted control signals from the remote device. In an exemplary embodiment, the remote device may be in the form of the user interface 202. For example, each of the first work vehicle 236 and the second work vehicle 238 may include one of the user interfaces 202 that is in communication with the vehicle controller 27 of the payload vehicle 220 via the communication interface 208. In this way, for example, the user interface 202 of the first work vehicle 236 may be used by the operator 232 to control operation of the payload vehicle 220. Alternatively or additionally, the user interface 202 of the second work vehicle 238 may be used by the operator 234 to control operation of the payload vehicle 220. In some embodiments, the vehicle controller 27 of the payload vehicle 220 includes a predefined prioritization for commands from the first work vehicle 236 and the second work vehicle 238. For example, the payload vehicle 220 may prioritize commands from the first work vehicle 236 until the particular task being performed by the first work vehicle 236 is completed, and then the payload vehicle 220 may switch to prioritize commands from the second work vehicle 238.

In another exemplary embodiment, multiple operators may operate a single payload vehicle 220 through the use of multiple user interfaces 202. In such an embodiment, one current operator (e.g., operator 232) may have control of the payload vehicle 220 at a time through the use of the user interface 202 on the first work vehicle 236. Accordingly, a second operator (e.g., operator 234) may request control of the payload vehicle 220 from the current operator prior to operating the payload vehicle 220. The request may be transmitted from the user interface 202 of the second work vehicle 238 to the user interface 202 of the first work vehicle 236 for display (e.g., visual, aural, haptic). The current operator may accept or reject the second operator's request through one or more interactions with the user interface 202 of the first work vehicle 236. In some embodiments, the payload vehicle 220 may be disabled from adjustment upon the transmission of a request to change operator control until the current operator either accepts or rejects the request.

In another exemplary embodiment, the payload vehicle 220 may automatically determine a “next working location” of the operator 232 and automatically travel to the “next working location” in anticipation of the operator 232 arriving at the “next working location.” By way of example, the operator 232 may be required to install brackets in specific locations for networking devices. These specific locations may be mapped in a database or in the memory of the payload vehicle 220. Likewise, the current and past locations of the first work vehicle 236 may also be stored in the database or in the memory of the payload vehicle 220. By comparing the current and past locations of the first work vehicle 236 and the specific locations of the brackets, the payload vehicle 220 may predict the “next working location” at which the operator 232 is required to install the next bracket by determining to which of the specific locations the first work vehicle 236 has not travelled to. In such an embodiment, the payload vehicle 220 may automatically travel to the “next working location” to be ready for the operator 232 when the first work vehicle 236 arrives at the “next working location.”

In some embodiments, the user interface 202 of the work vehicles 222 may be configured to display one or more selectable, graphical user elements or interfaces 240, 242 with which the operator may interact to transmit, by user interface 202, the control signals to the payload vehicle 220. The user interface 202 may include interactive elements for adjusting the various operating parameters of the payload vehicle 220. For example, the operator 232, 234 may selectively interact with the user interface 202 to adjust a steering angle, a direction of travel, a speed, a transmission gearing, an operational state, an operational mode, a platform elevation, an external warning (e.g., audible, visual), a charge state, etc. In some embodiments, the user interface 202 may be used to selectively control one or more payload vehicles 220. The operator 232, 234 may use the user interface 202 to select a desired vehicle to operate. In some embodiments, the operator may utilize the user interface 202 to simultaneously operate multiple vehicles. By way of example, when lifting an oversized payload 228, two payload vehicles 220 may be utilized. The two payload vehicles 220 may operationally linked upon receiving, from the user interface 202 of one of the work vehicles 222, a command to operate in tandem. Once operationally linked, a single command transmitted by the user interface 202 may be relayed to the two operationally linked payload vehicles 220 simultaneously. The one or more control signals may be the same control signal transmitted to the various payload vehicles 220. In other embodiments, the one or more control signals are used to move the payload vehicles 220 in coordination, but need not be the same control signal.

Various exemplary embodiments of the present disclosure exist and are described herein. One exemplary embodiment of the present disclosure is for the deployment of solar panel arrays. For example, in a construction zone, electricity is often used to power tools, lights, and equipment. A reliable electrical supply is not always available, and solar panels may provide a remote option for electrical generation and storage. In one embodiment, the work platform 22 of the payload vehicle 220 may be outfitted with an array of solar panels. The payload vehicle 220 may transport the solar panels to a location free from objects blocking the sunlight. The lift assembly 20 of the payload vehicle 220 may position the solar panel array at elevation to further reduce sunlight blockages. Likewise, the solar panel array may function as a sunshade for the operator 232, 234 when outside at elevation. In doing so, the payload vehicle 220 may supply shade and power to the operator 232, 234. For example, the payload vehicle 220 may include one or more electrical connection ports through which the operator 232, 234 may use to access the produced or stored electrical energy from the solar panel array. In some embodiments, the work platform 22 of the payload vehicle 220 may be equipped with an electrical storage device (e.g., a battery). In some embodiments, the payload vehicle 220 may be automatically or selectively disabled from moving when electrically coupled to one of the work vehicles 222 (e.g., when an electrical wire is running from the payload vehicle 220 to one of the work vehicles 222.

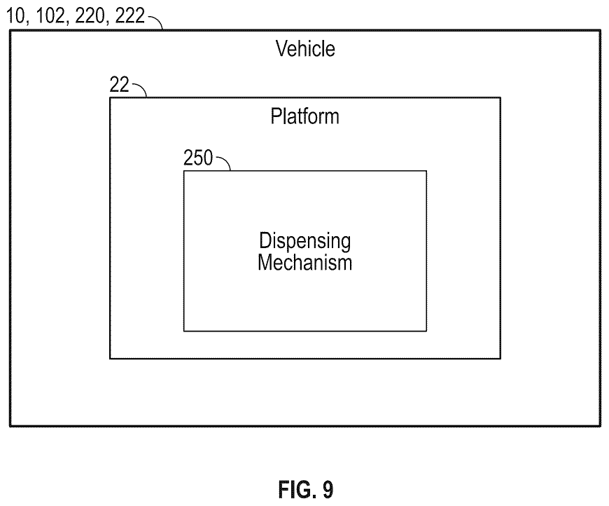

In some embodiments, the work platform 22 of the vehicle that delivers material to an operator (e.g., the vehicle 10, the payload vehicle 220, etc.) may include a dispensing mechanism 250, as shown in FIG. 9. The dispensing mechanism 250 is configured to selectively transport material along the work platform 22 and deliver the material (e.g., the payload 226, the payload 228, etc.) to an operator on the work vehicle (e.g., the vehicle 10, the articulating boom lift 102, the work vehicle 222, etc.). In some embodiments, the dispensing mechanism 250 may be in the form of a conveyor belt or platform, an actuator, a robotic arm, and/or a motor. In some embodiments, the dispensing mechanism 250 may be controlled by the operator in the work vehicle. For example, the user interface 202 may be used to control the dispensing mechanism 250, or the vehicle controller 27 may be in communication with the dispensing mechanism 250 and control the operation thereof.

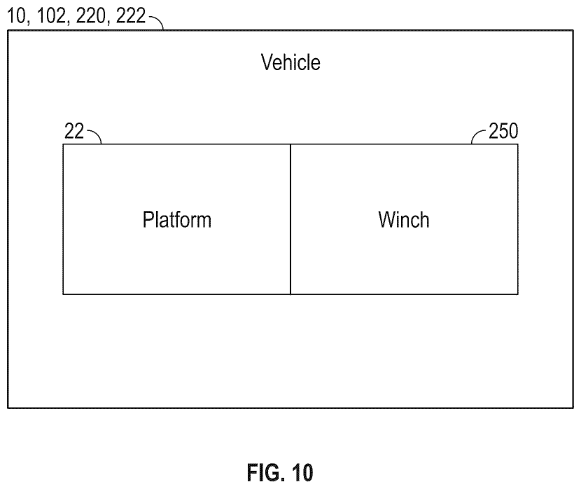

In some embodiments, the work platform 22 of the vehicle that delivers material to the worker (e.g., the vehicle 10, the payload vehicle 220, etc.) may include a winch 252 installed on a side of the work platform 22, as shown in FIG. 10. In some embodiments, the winch 252 may be used to transport material to and from the work platform 22 without requiring the lift assembly 20 of the work vehicle to extend or retract. In some embodiments, the winch 252 may be controlled by the operator in the work vehicle. For example, the user interface 202 may be used to control the winch 252, or the vehicle controller 27 may be in communication with the winch 252 and control the operation thereof.

Although this description may discuss a specific order of method steps, the order of the steps may differ from what is outlined. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule-based logic and other logic to accomplish the various connection steps, processing steps, comparison steps, and decision steps.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single-or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is coupled to the processor to form a processing circuit and includes computer code for executing (e.g., by the processor) the one or more processes described herein.

Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A system comprising:
a user interface;
a first lift vehicle including a first work platform; and
a second lift vehicle including:
a base;
a second work platform;
a lift assembly coupled between the base and the second work platform;
a lift actuator coupled to the lift assembly and configured to raise and lower the second work platform relative to the base;
at least one tractive element; and
a controller in communication with the user interface and configured to:
receive, from the user interface, a first control signal to lift the second work platform to a position proximate the first work platform; and
instruct the lift actuator to raise the second work platform to the position proximate the first work platform.

2. The system of claim 1, wherein the lift assembly is a scissor lift assembly including a plurality of support members that are pivotally coupled to one another.

3. The system of claim 2, wherein the plurality of support members includes a first support member and a second support member, wherein the lift actuator includes a first end coupled to the first support member and a second end coupled to the second support member.

4. The system of claim 1, wherein the first lift vehicle is a boom lift and the second lift vehicle is a scissor lift.

5. The system of claim 1, wherein the first lift vehicle is a first scissor lift and the second lift vehicle is a second scissor lift.

6. The system of claim 1, wherein the user interface is a mobile device, the mobile device configured to display one or more selectable, graphical elements that, upon receiving a selection, cause user interface to transmit one or more control signals to the controller.

7. The system of claim 1, wherein the user interface is arranged remotely from the first lift vehicle.

8. The system of claim 1, wherein the user interface is arranged within or coupled to the first lift vehicle.

9. The system of claim 1, wherein the controller is configured to:
receive, from the user interface, a second control signal to retrieve a payload;
instruct the lift actuator to lower the second work platform; and
instruct a drive motor and a steering system of the second lift vehicle to navigate to a loading location.

10. The system of claim 9, wherein the controller is configured to:
receive, from a load sensor, an indication that the payload is placed on the second work platform; and
instruct the drive motor and the steering system to navigate the second lift vehicle to the first lift vehicle.

11. The system of claim 1, wherein the controller is configured to:
receive, from a first vehicle controller of the first lift vehicle, an indication that the first lift vehicle moved from a first position to a second position; and
instruct the second lift vehicle to navigate to a location proximate to the second position.

12. The system of claim 11, wherein the controller is configured to instruct a drive motor and a steering system of the second lift vehicle to navigate to the location proximate to the second position.

13. The system of claim 12, wherein the controller is configured to instruct the lift actuator to adjust a height of the second work platform to navigate to the location proximate to the second position.

14. A system comprising:
a user interface;
a work lift vehicle including a first work platform; and
a payload lift vehicle including:
a base;
a second work platform;
a lift assembly coupled between the base and the second work platform;
a lift actuator coupled to the lift assembly and configured to raise and lower the second work platform relative to the base;
a traction element;
a drive motor configured to drive the traction element;
a steering system configured to steer the traction element; and
a controller in communication with the user interface and configured to:
receive, from the user interface, a first control signal to retrieve a payload;
instruct the drive motor and the steering system to navigate from a work location of the work lift vehicle to a loading location;
receive, from a load sensor, an indication that the payload is placed on the second work platform; and
instruct the drive motor and the steering system to navigate to the work location.

15. The system of claim 14, wherein the controller is configured to:
instruct the lift actuator to raise the second work platform to a position proximate to the first work platform.

16. The system of claim 14, wherein the work lift vehicle is a boom lift and the work lift vehicle is a scissor lift.

17. The system of claim 14, wherein the controller is configured to:
receive, from a first vehicle controller of the work lift vehicle, an indication that the work lift vehicle moved from the work location to a second location; and
instruct the payload lift vehicle to navigate to a location proximate to the second location.

18. The system of claim 17, wherein the controller is configured to instruct the drive motor and the steering system of the payload lift vehicle to navigate to the location proximate to the second location.

19. The system of claim 17, wherein the controller is configured to instruct the lift actuator to adjust a height of the second work platform to navigate to the location proximate to the second location.

20. A method of controlling a payload lift vehicle, the method comprising:
receiving, at a vehicle controller of a payload lift vehicle, a first control signal to retrieve a payload;
navigating, via a drive motor and a steering system of the payload lift vehicle, from a work location of a work lift vehicle to a loading location;
receiving, from a load sensor, an indication that the payload is placed on a work platform of the payload lift vehicle; and
navigating, via the drive motor and the steering system, to the work location of the work lift vehicle.
